(19) United States
(12) Patent Application Publication
(10) Pub. No.: US 2008/0270253 A1
(43) Pub. Date: Oct. 30, 2008

(54) Method for Performing an Electronic Transaction

(75) Inventor: Tea Vui Huang, Singapore (SG)

Correspondence Address: FASTH LAW OFFICES (ROLF FASTH), 26 PINECREST PLAZA, SUITE 2, SOUTHERN PINES, NC, 28387-4301, US

(73) Assignee: SMARTTRUST AB, Stockholm (SE)

(21) Appl. No.: 11/816,109

(22) PCT Filed: Feb. 14, 2005
(86) PCT No.: PCT/SE05/00201

§ 371 Date: Sep. 20, 2007

(51) Int. Cl. G06Q 30/00; G06Q 20/00

(52) U.S. Cl. 705/26

(57) ABSTRACT

The invention is concerned with a method for performing electronic transactions in a network comprising a mobile subscriber terminal with a digital wallet and a browser, a server for the management of the transactions and a content provider. In the method, the subscriber selects a service and sends an order request to the content provider. As a reply, the content provider sends a transaction order form to the mobile subscriber. The subscriber then confirms the transaction and sends the transaction order form to the browser. The browser reads data needed for the transaction form from the digital wallet and fills in the order form with the read transaction data. The completed form is then sent o the server, which converts the completed form into a standardized transaction format. The content provider processes the completed order form and sends it to the content provider, who replies to the subscriber. The invention is also concerned with said network.

### TECHNICAL FIELD

The invention is concerned with a method for performing an electronic transaction with a mobile phone.

### TECHNICAL BACKGROUND

The Global System for Mobile Communication (GSM) is a standard for digital wireless communications. GSM has much more services than just voice telephony. Today's second-generation GSM networks deliver high quality and secure mobile voice and data services (such as SMS/Text Messaging) with full roaming capabilities across the world.

The development of GSM Networks and terminals to support more advanced data bearer technologies has allowed for the introduction of new exciting data services and mobile applications.

The Subscriber Identity Module (SIM) inside GSM phones is a smart chip that was originally designed as a secure way to connect individual subscribers to the network. There is an on-going evolution of the SIM into a standardized and secure application platform for GSM and next generation networks. New functions added to the SIM card have enabled different applications and accelerated the move towards the mobile phone as a data terminal.

The SIM card will keep offering its intrinsic security to validate new services access and to secure transactions. The future generation of “Internet-like” phones will make the best use of the SIM card through the execution of authentication applications for service access and transaction acceptation, but also through its capability to store configuration and user data.

Today, numerous merchants are successfully conducting business on the internet using HTML-based forms. The data format used in these forms varies considerably from one merchant to another. End users find the diversity confusing and the process of manually filling in these forms to be tedious. The result is that many merchant forms are abandoned during the fill in process.

Software tools called electronic wallets can help this situation. A digital wallet is an application or service that assists consumers in conducting on-line transactions by allowing them to store billing, shipping, and payment information and to use this information to automatically complete merchant interactions. This greatly simplifies the check-out process and minimizes the need for a consumer to complete a merchant's form every time.

Digital wallets that fill forms have been successfully built into browsers, as helper applications to browsers, as stand-alone applications, as browser plug-ins, and as server-based applications. However, the proliferation of electronic wallets has been hampered by the lack of standards.

The Electronic Commerce Modeling Language (ECML) is an open internet standard for digital; wallets that supports automatic entry of consumer payment and shipping information into merchant order forms to facilitate automatic exchange of transaction information. It allows fast and secure online payment via a “digital wallet” in the phone.

ECML provides a set of simple guidelines for web merchants that will enable electronic wallets from different vendors to fill in their web forms. Shopping on the web is easy for the consumers when using ECML.

ECML may be used with any payment mechanism. It simply allows a merchant to publish consistent simple web forms. Many wallets and merchants plan to support ECML. It is an open standard and designed to be simple.

Examples of fields in an ECML form are information fields for name, postal address, telephone number, e-mail address, payment card details etc. There are a variety of methods of communication possible between the customer and the merchant. The easiest way of using the fields is probably to use an HTML form. More information about ECML can be found on the web address www.ecml.com and in the RFC 2706 Ecom field Names memo, “Field names for E-commerce”, written by the working group George Burne, Joe Coco and Kevin Weller.

US patent 2001/0007983 and EP patent application 1 168 264 are presented as prior art. US patent 2001/0007983 presents a method and system for transaction of electronic money with mobile communication unit as an electronic wallet, in which solution, the subscriber keys in necessary information. In EP 1 168 264, the subscriber does not have to manually enter payment details, since the transaction form is filled by a proxy server, which displays the pre-filled form for the user before transaction is completed.

The use of electronic wallets is, however, still troublesome in connection with mobile phones because of big data packets to be handled and sent from the mobile phone to the content provider. Big data packets run the risk of incomplete transactions and slow service response times.

### The Object of the Invention

The object of the invention is therefore to develop such practical solutions for electronic wallets to be used by mobile subscribers, wherein no big data packets have to be handled but which still are easy enough for the subscriber to use so that he would not be able to manually enter his transaction details every time a transaction is to be made.

### SUMMARY OF THE INVENTION

The invention is concerned with a method for performing electronic transactions in a network comprising a mobile subscriber terminal with a digital wallet and a browser, a server for the management of the transactions and a content provider. In the method, the subscriber selects a service and sends an order request to the content provider. As a reply, the content provider sends a transaction order form to the mobile subscriber. The subscriber then confirms the transaction and sends the transaction order form to the browser. The browser reads data needed for the transaction form from the digital wallet and fills in the order form with the read transaction data. The completed form is then sent o the server, which converts the completed form into a standardized transaction format. The content provider processes the completed order form and sends it to the content provider, who replies to the subscriber.

The invention is also concerned with said network.

In this document, a mobile ‘wallet’ refers to a reserved file space in a SIM file for storing m-commerce information (e.g. ECML type of data such as credit card numbers and credit card expiry dates etc). The basic usage of a wallet is for subscribers to store repeatedly requested and often-used personal transactional data (e.g. payment, shipping, billing etc).

The mobile phone is preferably a GSM station and the digital (also called electronic) wallet is in the SIM card of the mobile phone. The browser has an internet connection and the order request is initiated from a web site of the content provider. The order form sent from the content provider to the mobile subscriber is a Wireless Mark Up language Form (WML) form and the transaction data stored in the electronic wallet is in a shortened form, which can be anything, but largely dependent on the SIM's storage format. E.g. it can be stored in a linear order, where credit card number is the first item, followed by expiry date etc.

The standardized transaction format is the Electronic Commerce Modeling Language (ECML) standard. ECML in short defines standard data field names in HTML/WML forms for standard and widely used transaction data. The goal is to simplify and unite m-commerce via a common commerce transaction language.

Thus, the wallet application is based on existing technologies, such as WML and ECML (Electronic Commerce Modeling Language—an open standard IETF RFC 2706).

An m-commerce application can be used for the overall shopping process covering the beginning-to-end shopping process of product/service catalog browsing, shopping assistance (help messages/guides), login authentication (if needed), payment & receipt/confirmation issuance etc. On authorization from the subscriber, the m-commerce applications will then read these data from the SIM file, thus removing the need for the subscriber to key in the same transaction data for each and every time than they use the service, as well as for different services. Implementation wise, this would imply a SIM card with a Browser, a reserved SIM data storage file (for the wallet), and security plug-ins such as 3DES and/or RSA.

Advantages of the invention is that the data packets to be sent from the mobile phone to the content provider (as the long ECML field names are substituted with shorter names) via GSM and lease lines are small. Upload of small data packets has lower risk of incomplete transactions. Upload of small data packets also means fast service response times. In the method of the invention the non-standard wallet having data in a shortened form will be able to interface with open standard (ECML) applications. Wallet data stored in SIM in optimized and compressed format can be extracted and converted to ECML format by the Wallet Gateway and be transparent to 3^{rd} party applications.

In the following the invention is described by means of an example signal diagram. The intention is not to restrict the invention to the details of the example.

### FIGURES

FIG. 1 presents a signal diagram of an embodiment of the method of the invention

### DETAILED DESCRIPTION

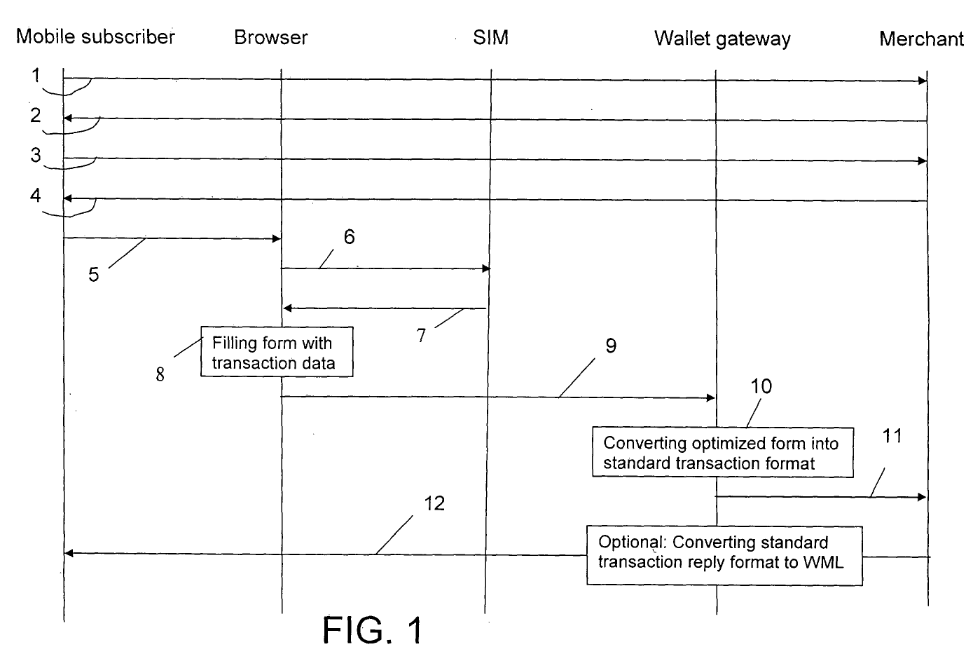

FIG. 1 presents an embodiment of the method of the invention, wherein a mobile subscriber orders a service from a content provider, here called “merchant”, and pays for the service by means of an electronic wallet in the mobile station. The mobile station has a browser with e.g. an internet connection to a content provider that offers services, such as web contents or items to buy.

The session starts with signal 1, with which the mobile subscriber browses for items or services to purchase. The signal of step 1 is e.g. a Uniform Resource Location (URL) request for a web page of a content provider. Step 1 is performed by the subscriber by writing and requesting the URL address of the web page wanted as a consequence of which the request is forwarded to the content provider.

With signal 2, the requested web page is sent to the subscriber as a reply to the request of step 1. The web page might display a list of options of different services, from which the subscriber selects one by e.g. clicking on the selected service, upon which an order of the selected service is sent back to the content provider in signal 3.

As a response to the order, the content provider sends an order form to the subscriber in signal 4. The form is a WML form sent down by an m-commerce application and contains fields or questions for transaction data, such as credit card number, expiry date etc.

In signal 5, the subscriber then confirms the service order and sends the service transaction form to the browser together with a password if needed.

The form has to be filled with transaction data and sent to the content provider to complete the order. Transaction data is stored in a wallet in the SIM card of the mobile phone. The WML form is executed in the browser and will read the wallet information from the SIM file. This is performed in signals 6 and 7, wherein the browser reads transaction data by letting the WML form fetch it from the SIM wallet. The browser then fills the form with transaction data in step 8. In signal 9, the browser sends the completed form to a wallet gateway.

The Wallet gateway converts the concatenated, optimized form into full-bodied ECML or any other equivalent standard based transaction format in step 10. In signal 11, the wallet gateway sends the converted transaction order to the content provider. The content provider then processes the transaction order and replies to the subscriber in step 12 by e.g. sending the web page, if the requested service was a web page or by just informing that order is executed. The reply from the content provider may need to be parsed and translated into a format that the browser can understand, e.g. from ECML to WML.

1. A method for performing electronic transaction in a network comprising a mobile subscriber terminal with a digital wallet and a browser, a server for the management of the transactions and a content provider, in which method the subscriber selects a service and sends an order request to the content provider, and in which method a) a transaction order form is sent from the content provider to the mobile subscriber, b) the subscriber confirms the transaction and sends a transaction order form to the browser, characterized by c) the browser reading data needed for the transaction form from the digital wallet, in which wallet the transaction data is stored in a shorter form, filling the order form with the read transaction data, and sending the completed form to the server, d) the server converting the completed form into a standardized transaction format and sending it to the content provider, e) the content provider processing the completed order form and replying to the subscriber.

2. The method of claim 1, wherein the mobile phone is a GSM station and the electronic wallet is in the SIM card of the mobile phone.

3. The method of claim 1, wherein the browser has an internet connection and the order request is initiated from a web site of the content provider.

4. The method of claim 1 wherein the order form sent from the content provider to the mobile subscriber is a Wireless Mark Up language Form (WML) form.

5. The method of claim 1 wherein the transaction data stored in the electronic wallet is in an optimal, compressed or concatenated format.

6. The method of claim 1 wherein the standardized transaction format is the Electronic Commerce Modeling Language (ECML) standard.

7. A network comprising a mobile subscriber terminal comprising a digital wallet and a browser, a server for the management of transactions and a content provider, the content provider having transaction order forms for transactions, wherein the digital wallet has non-standardized transaction data to be filled in the transaction form the browser has means for reading such data in a shorter form that is needed for a transaction form from the digital wallet, and for filling the order form with the read transaction data and sending it to the server, and the server has means for converting a non-standard transaction form to a standardized form.

8. The network of claim 7, wherein the mobile phone is a GSM station and the electronic wallet is in the SIM card of the mobile phone.

9. The network of claim 7 in that wherein the browser has an internet connection to the content provider.

10. The network of claim 7 wherein the order form in content provider is a Wireless Mark Up language Form (WML) form.

11. The network of claim 7 wherein the transaction data stored in the electronic wallet is in a an optimal, compressed or concatenated format.

12. The network of claim 7 wherein the standardized transaction format is the Electronic Commerce Modeling Language (ECML) standard.
